(19) United States
(12) Patent Application Publication
(10) Pub. No.: US 2018/0101834 A1
(43) Pub. Date: Apr. 12, 2018

(54) WIRELESS COMMUNICATION BEACON OFFER AND TRANSACTION SYSTEM

(71) Applicant: PAYPAL, INC., San Jose, CA (US)

(72) Inventor: Kevin Laracey, Natick, MA (US)

(21) Appl. No.: 15/287,106

(22) Filed: Oct. 6, 2016

(51) Int. Cl. G06Q 20/32; H04W 40/24

(52) U.S. Cl. CPC G06Q 20/325; H04W 40/244; G06Q 20/3224

(57) ABSTRACT

A customer communication system includes a non-transitory memory storing data that identifies a customer account and a merchant account, and one or more hardware processors coupled to the non-transitory memory and configured to execute instructions to cause the system to perform operations. The operations includes receiving, from a mobile customer device, beacon information that was received by the mobile customer device from a beacon broadcast by a merchant device, wherein the beacon information identifies a merchant associated with the merchant device. The operation further include determining that the mobile customer device is associated with the customer account and determining, using the beacon information, the merchant account. The operations further include identifying, using the customer account and the merchant account, a communication for transmittal to the customer device, and transmitting the communication to the mobile customer device.

### BACKGROUND

### Field of the Invention

The present invention generally relates to wireless communication beacons, and more specifically to the processing of offers and transaction via wireless communication beacons.

### Related Art

Mobile user devices such as, for example, mobile phones, may be used to conduct electronic transactions with merchant devices at merchant locations. Many merchant locations now include wireless communication beacons that may detect the mobile user device, or be detected by the mobile user devices, and may operate to enable the electronic transaction between the mobile user device and the merchant device. However, conventional wireless communication beacon systems suffer from a variety of drawbacks that complicate the electronic transaction process and have delayed the adoption by users and merchant of electronic transactions between their mobile user devices and merchant devices.

### BRIEF DESCRIPTION OF THE FIGURES

FIG. 1 is a block diagram illustrating an embodiment of a wireless communication beacon offer and transaction system.

FIG. 2 is a block diagram illustrating an embodiment of the wireless communication beacon offer and transaction system of FIG. 1.

FIG. 3 is a flowchart illustrating an embodiment of the operation of the wireless communication beacon offer and transaction system of FIGS. 1 and 2.

FIG. 4 is a screen shot illustrating an embodiment of a user interface that may be provided in the wireless communication beacon offer and transaction system of FIGS. 1 and 2.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that provide wireless communication beacon(s) at a merchant location and use those wireless communication beacons to communicate with mobile customer devices to determine offers and communicate those offers to customers via their respective customer devices. The systems and techniques described herein may be applied to “beacons” as well as “geofences”, and for the purposes of the present disclosure, a “beacon” may be information broadcast by a wireless communication beacon or a merchant device (e.g., a point of sale payment device) via one or more communications standards (e.g., Near Field Communications, Bluetooth, Bluetooth Low Energy, WiFi, any IEEE standard, or any other electromagnetic based communications techniques), while a “geofence” may be similar to a beacon (i.e., by broadcasting information) but may also be associated with a virtual barrier that provides for the detection, or allows a mobile customer device to detect, when a customer has entered the merchant location and/or a specific area in the merchant location.

In an embodiment, a mobile customer device may detect a beacon broadcast by a merchant device, or determine that it is within a geofence and, in response, may communicate through a network with a system provider device (e.g., a “cloud” device or other device connected to the mobile customer device via the Internet). The communications by the customer device with the system provider device in response to detecting the beacon or entering the geofence may include an exchange of customer metadata that identifies the customer and/or information about the customer, beacon metadata that identifies the information broadcast by the merchant device, merchant or system provider metadata the identifies the owner and/or operator that caused the beacon and/or geofence to be provided and/or information about the owner/operator that caused the beacon and/or geofence to be provided, location data that identifies the current location or area of the mobile customer device, a Uniform Resource Identifier (URI) that is configured to direct devices to a network or network location to obtain further data or metadata, and/or a variety of other information that would be apparent to one of skill in the art in possession of the present disclosure. In a specific example, a URI may be exchanged between the system provider device and the mobile customer device in order to enable the provision of additional communications when the beacon or geofence does not enable the provisioning of such information. In such situations, the URI may direct the system provider device to a network location such as a network maintained by the merchant, and the system provider device may then receive the additional information.

In an embodiment, upon receiving data communicated by the mobile customer device in response to detecting the beacon or geofence, the system provider device may determine an action to perform such as, for example, the communication of information (e.g,. offers) to the customer device, the processing of a transaction, the updating of a status of an account, and/or other actions that would be apparent to one of skill in the art in possession of the present disclosure (including determinations to perform no action). For example, the communication of information by the system provider device may include sending the mobile customer device a message or notification that the customer has an offer in n customer account that is associated with the merchant, or sending the customer a new offer associated with the merchant.

In an embodiment, the beacon broadcast at the merchant location may include a Universally Unique Identifier (UUID), major and minor values, and/or other beacon information known in the art. For example, the major and minor values may be included within a token. Any or all of the beacon information may be included within a beacon value, and that beacon value may be broadcast by a merchant device at a merchant location using, for example, Bluetooth wireless communication systems (e.g., Bluetooth Low Energy BLE) and/or other wireless communications systems known in the art. Additional beacon information may include information directed towards an acceptance partner (e.g., the merchant or a partner of the merchant), a merchant address (e.g., a street address, ZIP code, state, country, or longitudinal and latitudinal location), a merchant location (e.g., location within a building at the street address), and/or other information that would enable the functionality discussed below, and any or all of that information may be detected by the mobile customer device and/or transmitted to the system provider device. In some embodiments, the beacon information detected by the mobile customer device and transmitted to the system provider device may allow the system provider device to detect a location of the beacon and perform actions based on to that location.

In some embodiments, the system provider device may be associated with a plurality of different merchants, and each merchant may operate at least one wireless communication beacon, along with one or more wireless communication beacon networks. For example, a wireless communication beacon network may include a plurality of wireless communication beacons that, upon detection by a mobile customer device of a beacon transmitted by any or all of those wireless communication beacons and transmission of the beacon information from the beacon to a system device, all operate perform the same action(s). Accordingly, a national merchant (i.e., a merchant with many different merchant locations across the United States) may maintain a wireless communication beacon network for their merchant locations in a first state and another wireless communication beacon network for their merchant locations in second state. As such, that merchant may then be able to offer customers (via their respective customer devices) detected within their stores in the first state deals and discounts that are separate and distinct from deals and discounts offered to customers within their stores in the second state. In a specific example, the system provider device may confirm certain details associated with a detected customer, customer device, or customer account associated with the customer and/or customer device before performing any of the actions described below such as, for example, determining a balance of the customer account before offering a discount to the customer (e.g., the system provider device may offer a discount to a customer when the customer account includes a balance).

In an embodiment, the mobile customer device may utilize software such as a mobile device application that is configured to determine the frequency of a beacon broadcast by the wireless communication beacon and, if the beacon or wireless communication beacon is detected multiple times within a set time period, ignore the beacon and/or not transmit beacon information retrieved from the beacon to the system provider device. For example, the mobile customer device may, upon detecting a beacon or communications from the same wireless communication beacon three times in a 24 hour period, ignore the beacon or wireless communication beacon, and/or not retrieve and transmit beacon information included in the beacon to the system provider device (i.e., until that beacon is detected in a subsequent 24 hour period.)

In an embodiment, the system provider device may, upon receiving the beacon information that was included in the beacon broadcast by the wireless communication beacon and retrieved and transmitted by the mobile customer device, transmit discounts, offers, advertisements, coupons, notifications, event campaigns, and/or other information to the mobile customer device. For example, the system provider device may transmit an offer to the mobile customer device of the customer that includes a discount with the merchant (e.g., a 10% discount), a credit for their customer account (such as a $10 credit), a notification that the merchant will be changing their operating hours, and/or other information that would be apparent to one of skill in the art in possession of the present disclosure. In another example, a merchant may have certain merchant branches or locations that support loyalty points, while other merchant branches or merchant location do not support such loyalty points, and the mobile customer device and/or the system provider device may be configured to differentiate between whether the mobile customer device is located at a merchant location that supports loyalty points or is located at a merchant location that does not support loyalty points. If the system provider device detects (or is informed by the mobile customer device) that the mobile customer device is at a merchant location that supports loyalty points, the system provider device may determine that the customer has a balance in their customer loyalty points accounts and transmit a message to the mobile customer device to inform the customer of the balance on their customer loyalty account.

As discussed above, upon receiving beacon information transmitted by the mobile customer device, the system provider device may transmit notifications and/or other information to the mobile customer device. For example, the system provider device, upon receiving the beacon information from the mobile customer device, may determine a location of the mobile customer device (which may be the merchant location at which the mobile customer device is located), and may then determine whether to send notifications and/or other information (e.g., offers, coupons, deals, ads, etc.) to the mobile customer device based on the merchant location and/or merchant that is associated with that merchant location. In some embodiments, the beacon information may include one or more URIs, and the system provider device may access the network location using the URIs to obtain information, determine whether to communicate information, and/or otherwise perform the information provision with the mobile customer device. In other embodiments, the system provider device may communicate one or more of the URIs (or a URL associated with a URI) to the mobile customer device to allow the customer to access information on the mobile customer device. Furthermore, messages sent to the mobile customer device by the system provider device may be configured to allow user interaction with the message, which may allow the customer to provide inputs on a message (e.g., a “swipe”, a “tap”, etc.) to access additional information such as offers or user specific ads, etc.

As discussed above, beacons may be broadcast by a merchant device. For example, the merchant device may include a point of sale device such as a portable card reader, a kiosk, a checkout device, an automated teller machine, and/or another devices known in the art that are utilized in receiving payments and/or other information from customers. The merchant device may include a wireless communication system such as, for example, a BLE-enabled Bluetooth chip that is configured to operate in multiple modes that may include a first mode that is configured to enable payments (e.g., contactless payments), and a second mode that is configured to operate as a location device (e.g., by transmitting beacon(s) including beacon information.) For example, the merchant device may be configured to transmit beacon(s) including beacon information when the merchant device is not being used to enable payments. In another example, the mobile customer device may configured to transmit beacon information (e.g., information received from a beacon broadcast by the merchant device) to secondary devices such as, for example, wearable devices that may include smart watches, fitness trackers, smart glasses, and/or other secondary devices known in the art. As such, in some embodiments, the mobile customer device may transmit information to and receive information from secondary devices and use that information to communicate further with other devices such as the merchant device, the system provider device, etc.

In some embodiments, the merchant device may be configured to provide a first mode of operation (e.g., a “code on point of sale” mode) in which the merchant device emits a beacon including beacon information (such as a BLE transaction identifier) at a very low broadcast power that requires that the mobile customer device be in relatively close proximity to the merchant device (e.g., a few feet) to detect the beacon, ensuring that only mobile customer device(s) with which transactions are to be performed can access the beacon information. For example, a transaction identifier provided using a very low broadcast power may include information associated with a transaction, a token associated with the transaction, and/or any other information necessary to perform the transaction. Upon receiving an identifier, token, or other transaction information, the mobile customer device may then assist in the processing of the transaction by, for example, communicating the identifier, token, or other transaction information to the system provider device.

In some embodiments, the merchant device may also be configured to provide a second mode of operation (e.g., a “code on phone” mode) in which the merchant device generates a value that may represent a transaction or an electronic wallet token (e.g., associated with a customer wallet that is provided by the system provider device or other electronic wallet provider), and transmits that value to the mobile customer device and/or the merchant device. For example, the merchant device may identify whether a mobile customer device that is proximate the merchant device (e.g., a mobile customer device detected by the merchant device via BLE communications) intends to make a payment (e.g., a contactless payment). In such examples, the mobile customer device may include software that is configured to detect an identifier that is provided in a particular format in a beacon broadcast by the merchant device, and communicate a response upon detecting the identifier. Similarly as discussed above, identifiers may be broadcast by the merchant device at a relatively low power level to ensure that only mobile customer devices in relatively close proximity to the merchant device may receive the identifiers. In response to receiving the identifier, the mobile customer device may transmit a confirmation that the identifier was received and/or deliver a transaction token or an electronic wallet token to the merchant device (e.g., a point of sale device).

In an embodiment, transaction or electronic wallet tokens may include a single payment instruction or the merchant device, or may refer to a customer electronic wallet that is provided by the system provider device or other electronic wallet provider and that includes multiple payment instruments that may be used to perform a transaction. For example, upon receiving beacon information in a beacon broadcast by the merchant device, the mobile customer device may use the beacon information to sign or encrypt information (e.g., a token stored on the customer mobile device or retrieved in real time from the system provider device) and send the resulting signed or encrypted information (“the package’) to the merchant device. The merchant device may then transmit the package to the system provider device, and the system provider device may utilize the information in the package as a payment instrument token, and electronic wallet token, or other transaction information. In other embodiments, a token or a transaction ID (e.g., generated by the merchant device, mobile customer device, or system provider device, and referencing a transaction between the customer and the merchant) may be encrypted using a public key stored on the mobile customer device, and then transmitted to the merchant device. The merchant device may then decrypt the token or transaction ID and transmit the decrypted token or transaction ID to the system provider device (possibly with the private key) for processing of the transaction, or transmit the encrypted token or transaction ID to the system provider device so that the system provider device may perform the decryption (e.g., using a copy of the private key provided by the merchant device or stored by the system provider device) in order to process the transaction.

In an embodiment, the merchant device may be configured to broadcast information (e.g., beacon information) using one or more location device profiles. For example, device profile(s) may be utilized by the merchant device to broadcast beacons that include beacon information in format(s) that may be read with different mobile customer device types. As such, the merchant device may be able to broadcast beacons that include beacon information in, for example, Apple® iBeacon® format, Google® location device format, altbeacon.org format, and/or in other beacon formats know in the art. In a specific example, each type of format may include a separate device profile that may be stored on the merchant device or in a device communicatively connected to the merchant device, and the device profiles may be updated (e.g., by a remote system connected to the merchant device through a network) in part (e.g., by updating individual components of the profile) or as a whole (e.g., replacing the profile with a new, updated profile). Furthermore, device profiles may include parameters such as, for example, BLE major and minor values, UUIDs, and/or other device profile parameters known in the art, and this parameters may include a broadcast interval (e.g., an interval in milliseconds), a rotation interval (e.g., instructions to broadcast the beacon with an iBeacon profile first, an altbeacon.org profile second, a Google location device format third, and so on), a power level at which to broadcast the beacon, and/or other parameters that would be apparent to one of skill in the art in possession of the present disclosure.

Thus, a system and method have been described that include a mobile customer device that may utilized electronic wallet software to detect beacons broadcast at a merchant location by a merchant device such as an automated teller machine, a payment kiosk, a check-out counter, point of sale (POS) device, and/or other merchant devices known in the art. The techniques described herein may be performed via communications between the mobile customer device and the merchant device through any wireless communication techniques including, for example, Bluetooth standard protocols such as Bluetooth Low Energy, Wi-Fi, Near Field Communications (NFC), Quick Response (QR) codes, bar codes, other codes known in the art, wired data transmissions, and/or other communication techniques known in the art. It is understood that though certain embodiments may be described as being performed with one or more particular communication techniques, such description is illustrative and is not meant to limit the use of other possible communication modes.

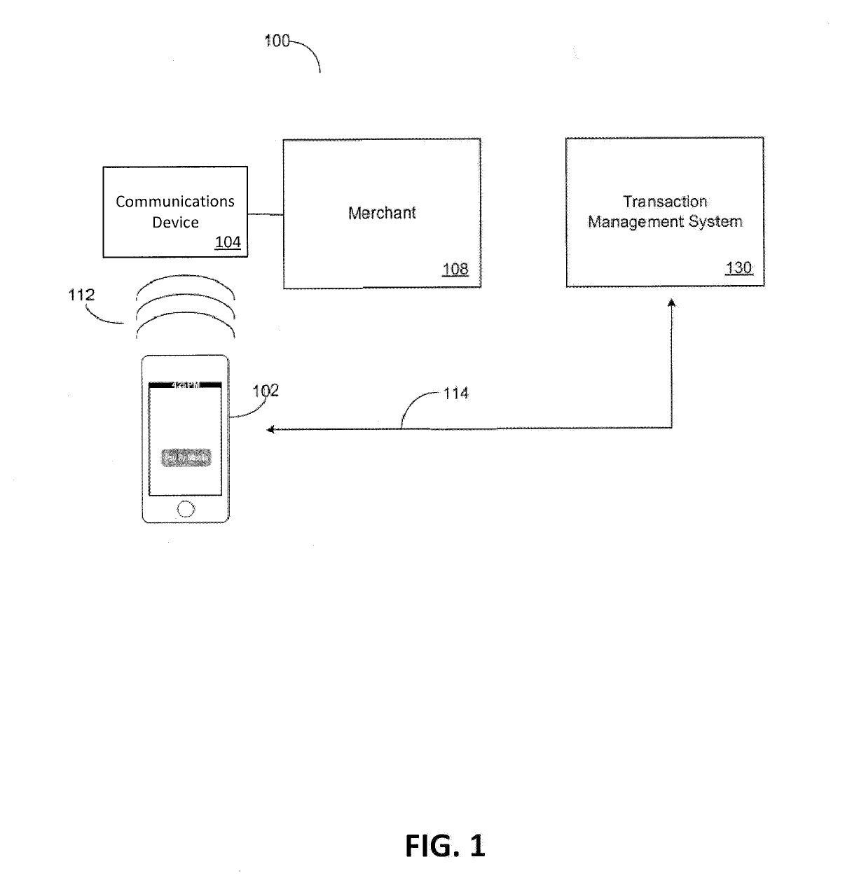

The systems and methods of the present disclosure may be performed with a variety of payment systems known in the art. For example, FIG. 1 includes a block diagram that illustrates an embodiment of a payment system that includes a mobile customer device 102, a communications device 104 (e.g., the merchant device discussed above), a merchant 108, and a transaction management system 130 (e.g., the system provider device discussed above). In the illustrated embodiment, the mobile customer device 102 is in communication with the transaction management system 130 via a communication path 114 that may allow direct or indirect communication between the mobile customer device 102 and the transaction management system 130, and in communication with the communications device 104 via a communication path 112.

A customer may have, use, or operate the mobile customer device 102, which may be, for example, a smartphone, a personal data assistant, a tablet, a wearable electronic device (e.g., a smart watch, electronically augmented glasses, etc.), a laptop, and/or other electronic devices known in the art. The mobile customer device 102 may also include a user interface that may be provided on one or more of a display screen, and may be interacted with using a data entry device such as a keypad or touch screen, other input buttons, facial or movement recognition technology, and/or using other techniques know in the art for allowing a user to interface with the mobile customer device 102.

The communications device 104 may be provided, for example, as part of (e.g., connected to or a component of) a point of sale terminal, and the point of sale terminal may be a kiosk, an automated teller machine, a checkout machine, a mobile device, a scanner, and/or other device known in the art that are used to interact with a customer to purchase, check out, and/or pay for goods or services. The merchant 108 may include, for example, a physical store, an electronic commerce network location, a mail order and/or telephone merchant, a vending machine, kiosk, other unattended devices, and/or any individual or entity that offers products or services for purchase. The communications device 104 may allow communications (e.g., between the merchant 108 and the mobile device 102) over the various communications protocols discussed above including Bluetooth, Bluetooth Low Energy (BLE), WiFi, NFC, QR codes, bar codes, other codes, wired data transmission, and/or other communication techniques known in the art. As discussed above, the communications device 104 may broadcast a beacon or geofence that is detectable by the mobile customer device 102.

The transaction management system 130 may be provided as the system provider device that includes one or more servers that are communicatively coupled to a storage system that stores data associated with customers and customer accounts. Such data may include, for example, customer account identifiers (e.g., customer account numbers), customer information such as names, contact information (e.g., phone numbers, e-mail addresses, social media account identifiers, messaging service account identifiers, and/or other contact information known in the art), customer contact preferences, customer financial account information (e.g., bank account information, balance information, credit card numbers, expiration dates, PIN numbers, and/or other financial information known in the art), customer account balances, customer location information (e.g., previously locations in which the customer has been detected via their mobile customer device), and/or other information associated with the customer or customer account. The transaction management system 130 may operate to process transactions carried out between the mobile customer device 102 and the communications device 104 of the merchant 108 by, for example, confirming payments associated with transactions and transferring funds from the customers account to the merchants account.

In an embodiment, the communication between the mobile customer device 102 and the transaction management system 130 via one or more payment networks may be direct or indirect communication. For example, direct communication may be communication where the mobile customer device 102 is directly in contact with one or more servers of the transaction management system 130, while indirect communication may be communication where the mobile customer device 102 is in communication with one or more servers of the transaction management system 130 via one or more intermediaries such as a merchant processing system or a gateway provider system.

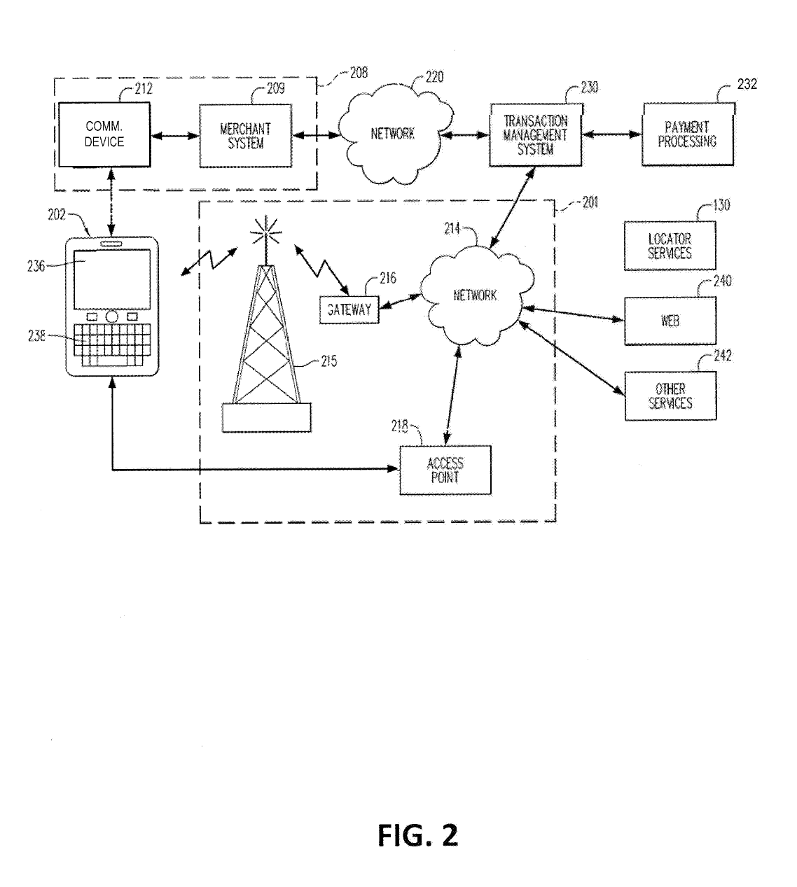

Further details of the payment system of the present disclosure are provided in FIG. 2. FIG. 2, which includes a block diagram illustrating an embodiment of the payment system. The payment system of FIG. 2 includes a mobile customer device 202, a merchant device 208, a transaction management system 230 (which may provide at least a portion of the system provider device discussed above), and payment processing systems 232 (which may provide at least a portion of the system provider device discussed above). In an embodiment, the mobile customer device 202 may include communication subsystems that are configured to allow the mobile customer device 202 device to be operated pursuant to ISO/IEC 18092, NFC IP-1, the ISO/IEC 14443 contactless communication standards, and/or other contactless communication standards known in the art, and may include wireless technologies such as RFID, Bluetooth, NFC, and/or other wireless technologies known in the art. In several embodiments, the mobile customer device 202 may include a payment application that is configured to allow the mobile customer device 202 to perform the functionality discussed herein.

The mobile customer device 202 may be configured to communicate over one or more wired and/or wireless networks 201. As an example, a wireless network may include a cellular network (represented by a cell transmitter 215), and the mobile customer device 202 may communicate over the cellular network (or other wireless network), through a gateway 216, and through a network 214 (e.g., the Internet and/or other public and/or private network). An access point, such as the access point 218 illustrated in FIG. 2, may be provided to facilitate communication access and/or data transfers via the network 214. In a specific example, the access point 218 may be compliant with the 802.11g standard, Bluetooth standards, and/or other communication standards known in the art.

The mobile customer device 202 includes a display screen 236 and a data entry device 238 (e.g., a keypad, touch screen, voice interface, and/or other data entry devices known in the art). As discussed above, the customer may use the mobile customer device 202 to receive information and have that information displayed on the display screen 236. In some embodiments, the mobile customer device 202 may also include a camera (not illustrated) or other image capture device which may allow the mobile customer device 202 to capture an image or representation of a checkout token and/or other transaction identifier. The mobile customer device 202 may also capture, generate, or otherwise obtain a checkout token and transmit that checkout token to the merchant 208 via wireless technologies such as NFC, Bluetooth, Bluetooth Low Energy, Wi-Fi, audio, and/or other communication techniques known in the art.

The merchant device 208 may include one or more merchant systems 209 to are configured to process payments and transactions, including the payment transactions discussed herein as well as “traditional” or standard payment transactions involving cash, standard payment cards, and other transaction instruments known in the art. For example, the merchant system(s) 209 may include a networked point of sale system (e.g., including POS systems providing in a physical retail location), a shopping cart system (e.g., including an electronic network commerce subsystems utilized in Internet retail locations). The merchant system(s) 209 may include a combination of subsystems that are configured to allow a merchant to accept payments for goods or services. As discussed above, the merchant system(s) 209 may be used with the one or more communication devices 212 to broadcast information to and receive information from customers via their customer mobile device 202. For example, the communication devices 212 may broadcast a beacon, and the mobile customer device 202 may detect the beacon and retrieve beacon information from that broadcast beacon. As discussed above, the communications device 212 may include a, Bluetooth Low Energy, NFC, and/or other wireless communication systems that are configured to enable communications between the mobile customer device 202 and the communications device(s) 212.

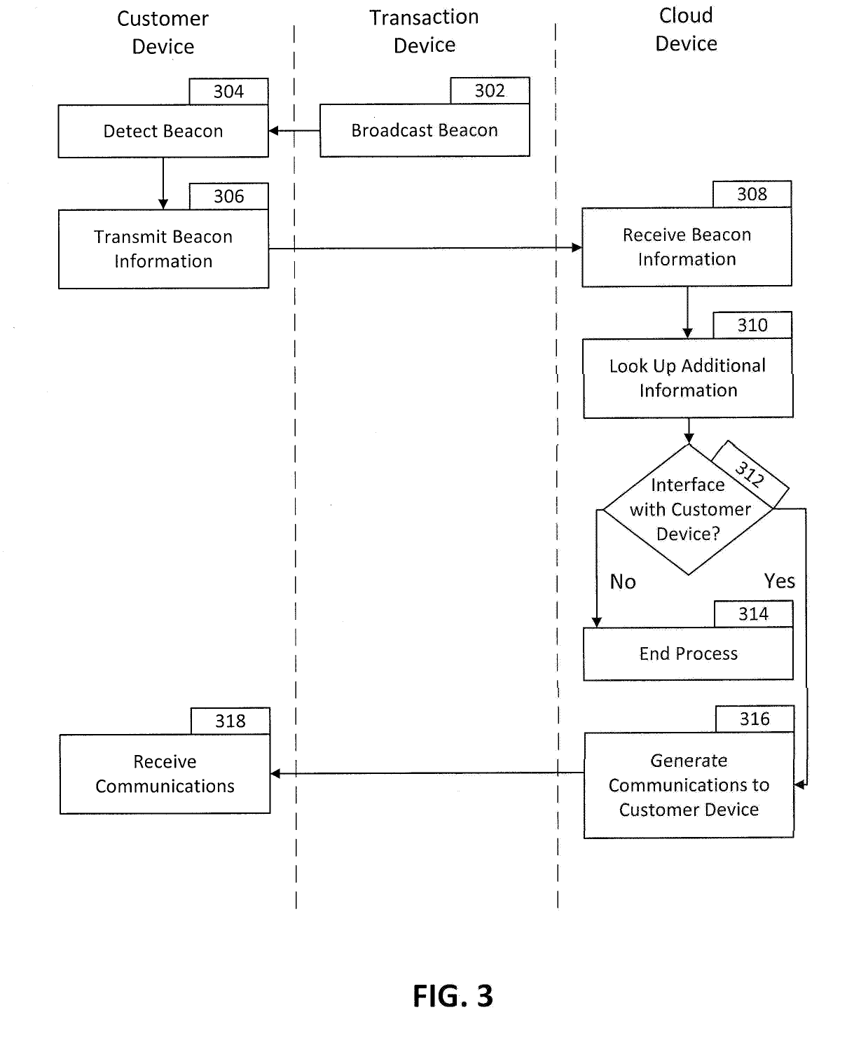

FIG. 3 provides a flowchart that illustrates an embodiment of a beacon detection and offer process that may be performed using the payment systems discussed above. The flowchart of FIG. 3 divides the beacon detection and offer process into elements performed by a customer device, elements performed by a transaction device, and elements performed by a cloud device. In an embodiment, the customer device may be, for example, the mobile customer devices 102 or 202 discussed above with reference to FIGS. 1 and 2, the transaction device may be, for example, the merchant devices discussed above with reference to FIGS. 1 and 2, and the cloud device may be the system provider devices discussed above with reference to FIGS. 1 and 2. It should be appreciated that different embodiments may include different devices that perform processes using different components than are illustrated in FIG. 3 while remaining within the scope of the present disclosure. Thus, the processes illustrated in FIG. 3 as being performed by the customer device may be performed, in different embodiments, by the transaction device and/or the cloud device, the processes illustrated in FIG. 3 as being performed by the transaction device may be performed, in different embodiments, by the customer device and/or the cloud device, and the processes illustrated in FIG. 3 as being performed by the cloud device may be performed, in different embodiments, by the transaction device and/or the customer device.

In an embodiment of block 302, the transaction device may broadcast a beacon within, for example, a merchant location, and the customer device may detect the beacon at block 304. The beacon may include beacon information such as, for example, an identity of the merchant, the location of the merchant, specific store information (e.g., store number) for the merchant, and/or other merchant information that would be apparent to one of skill in the art in possession of the present disclosure. The beacon information may then be transmitted by the customer device at block 306 and received by the cloud device at block 308.

Upon receiving the beacon information, the cloud device may look up additional information using the beacon information at block 310. For example, at block 310 the cloud device may determine whether there is a discount or special offer that may be sent to customers that visit the merchant location identified in the beacon. In addition, the cloud device may look up additional information via an internal database maintained by the operator of the cloud device or via an external database such as a website maintained by the merchant. The cloud device may then determine whether to interface (e.g., transmit information to) the customer device at block 312. If the cloud device determines that further communications with the customer device is not needed, the process may end at block 314.

If at block 314 the cloud device determines that further communications with the customer device are appropriate, the cloud device may generate and transmit the communications to the customer device at block 316. For example, the cloud device may determine that the customer device is in a first store of the merchant that is running a promotion, and thus information about that promotion should be communicated to the customer device. AIn another example, the cloud device may determine that the customer has reached a milestone associated with his or her customer account such as, for example, an anniversary date, a spending milestone (e.g., $500 spent), etc., and may provide a discount to the customer device. The customer device may then receive the communications from the cloud device at block 318.

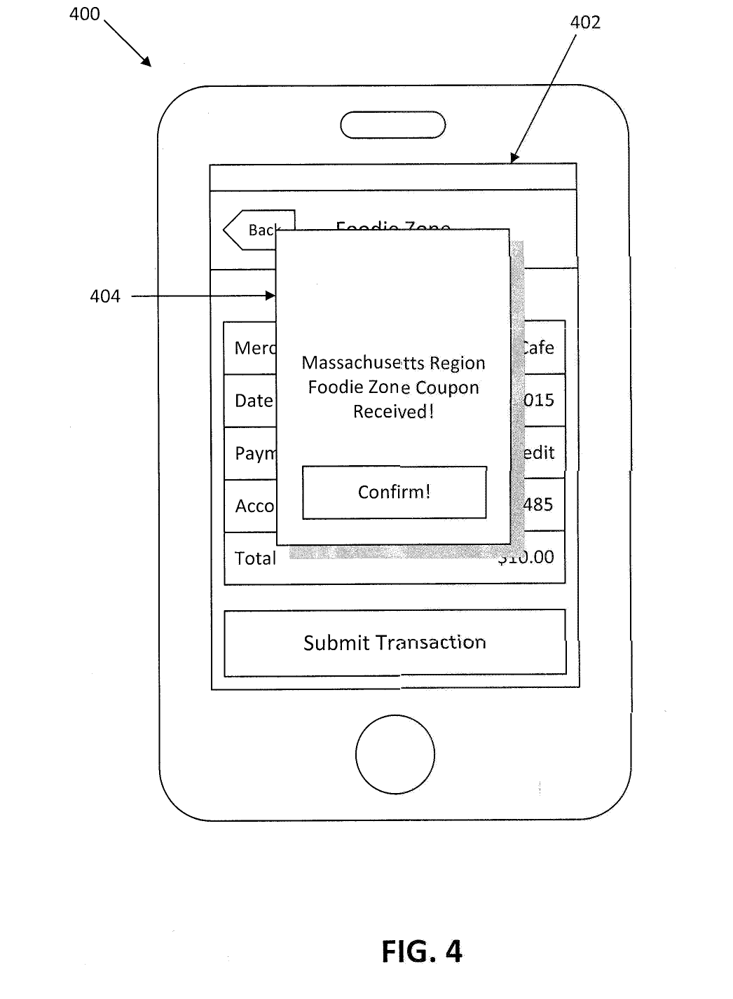

FIG. 4 illustrates an embodiment of a user interface 402 that may be provided in the payment system described above using a mobile customer device 400. In the illustrated example, the customer device 400 is located in a Massachusetts region store of a merchant called Foodie Zone, and upon entering Foodie Zone, the mobile customer device 400 may detect a beacon emitted by a merchant device in Foodie Zone and retrieve beacon information included in that beacon. That beacon information may then be communicated to a system provider device and, in response to receiving that beacon information, the system provider device may communicate data back to the mobile customer device 400 that causes the mobile customer device 400 to display the user interface 402 that includes a message informing the customer that a special coupon for the Massachusetts region has been received.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A customer communication system comprising:
a non-transitory memory storing data that identifies a customer account and a merchant account; and
one or more hardware processors coupled to the non-transitory memory and configured to execute instructions to cause the system to perform operations comprising:
receiving, from a mobile customer device, beacon information that was received by the mobile customer device from a beacon broadcast by a merchant device, wherein the beacon information identifies a merchant associated with the merchant device;
determining that the mobile customer device is associated with the customer account;
determining, using the beacon information, the merchant account;
identifying, using the customer account and the merchant account, a communication for transmittal to the customer device; and
transmitting the communication to the mobile customer device.

2. The system of claim 1, wherein the operations further comprise:
receiving, from the mobile customer device, a transaction token that was retrieved by the mobile customer device from the beacon broadcast by the merchant device; and
processing a transaction involving the customer account and the merchant account using the transaction token.

3. The system of claim 2, wherein transaction token was retrieved by the mobile customer device from the beacon broadcast by the merchant device in a low power broadcast mode.

4. The system of claim 1, wherein the operations further comprise:
receiving, from the merchant device, a transaction token that was received by the merchant device from the mobile customer device; and
processing a transaction involving the customer account and the merchant account using the transaction token.

5. The system of claim 4, wherein the transaction token was received by the merchant device from the mobile customer device in response to the mobile customer device receiving an indicator transmitted by the merchant device via a low power broadcast mode.

6. The system of claim 1, wherein the identifying the communication for transmittal to the customer device incudes accessing a database maintained by a merchant associated with the merchant device.

7. The system of claim 1, wherein the communication includes a discount for a product offered for sale by a merchant associated with the merchant device.

8. A method for communicating with a customer, comprising:
receiving, by a system provider device from a mobile customer device, beacon information that was received by the mobile customer device from a beacon broadcast by a merchant device, wherein the beacon information identifies a merchant associated with the merchant device;
determining, by the system provider device, that the mobile customer device is associated with the customer account;
determining, by the system provider device using the beacon information, the merchant account;
identifying, by the system provider device using the customer account and the merchant account, a communication for transmittal to the customer device; and
transmitting, by the system provider device, the communication to the mobile customer device.

9. The system of claim 8, further comprising:
receiving, by the system provider device from the mobile customer device, a transaction token that was retrieved by the mobile customer device from the beacon broadcast by the merchant device; and
processing, by the system provider device, a transaction involving the customer account and the merchant account using the transaction token.

10. The system of claim 9, wherein transaction token was retrieved by the mobile customer device from the beacon broadcast by the merchant device in a low power broadcast mode.

11. The system of claim 8, further comprising:
receiving, by the system provider device from the merchant device, a transaction token that was received by the merchant device from the mobile customer device; and
processing, by the system provider device, a transaction involving the customer account and the merchant account using the transaction token.

12. The system of claim 11, wherein the transaction token was received by the merchant device from the mobile customer device in response to the mobile customer device receiving an indicator transmitted by the merchant device via a low power broadcast mode.

13. The system of claim 8, wherein the identifying the communication for transmittal to the customer device incudes accessing a database maintained by a merchant associated with the merchant device.

14. The system of claim 8, wherein the communication includes a discount for a product offered for sale by a merchant associated with the merchant device.

75. A non-transitory, machine-readable medium having stored thereon machine- readable instruction executable to cause a machine to perform operations comprising:
receiving, from a mobile customer device, beacon information that was received by the mobile customer device from a beacon broadcast by a merchant device, wherein the beacon information identifies a merchant associated with the merchant device;
determining that the mobile customer device is associated with the customer account;
determining, using the beacon information, the merchant account;
identifying, using the customer account and the merchant account, a communication for transmittal to the customer device; and
transmitting the communication to the mobile customer device.

16. The system of claim 15, wherein the operations further comprise:
receiving, from the mobile customer device, a transaction token that was retrieved by the mobile customer device from the beacon broadcast by the merchant device; and
processing a transaction involving the customer account and the merchant account using the transaction token.

17. The system of claim 16, wherein transaction token was retrieved by the mobile customer device from the beacon broadcast by the merchant device in a low power broadcast mode.

18. The system of claim 15, wherein the operations further comprise:
receiving, from the merchant device, a transaction token that was received by the merchant device from the mobile customer device; and
processing a transaction involving the customer account and the merchant account using the transaction token.

19. The system of claim 18, wherein the transaction token was received by the merchant device from the mobile customer device in response to the mobile customer device receiving an indicator transmitted by the merchant device via a low power broadcast mode.

20. The system of claim 15, wherein the identifying the communication for transmittal to the customer device incudes accessing a database maintained by a merchant associated with the merchant device.
